(19) United States
(12) Patent Application Publication
(10) Pub. No.: US 2016/0175190 A1
(43) Pub. Date: Jun. 23, 2016

(54) FOOT SPA

(71) Applicants: Chris Alexander, Ontario (CA); Minh Sang Tran, Cambridge (CA)

(72) Inventors: Chris Alexander, Ontario (CA); Minh Sang Tran, Cambridge (CA)

(21) Appl. No.: 14/979,116

(22) Filed: Dec. 22, 2015

Related U.S. Application Data
(60) Provisional application No. 62/095,173, filed on Dec. 22, 2014.

(51) Int. Cl. A61H 35/00; A61H 33/00

(52) U.S. Cl. CPC A61H 35/006; A61H 33/0087; A61H 2201/1215

(57) ABSTRACT

The improved spa includes: a basin; a rotating motor element; an impeller which, in use, rotates to circulate water in the basin; and a magnetic coupling which couples the element to the impeller to provide for said rotation of the impeller. The coupling has a drive hub coupled to the element for co-rotation and a driven hub coupled to the impeller for co-rotation. The impeller is defined by blades carried by the driven hub. The improvement comprises a housing defined by a base and a cover, the base having a recess which receives the driven hub in close-fitting relation. The cover is secured to the base and defines, in combination therewith, a void in which the blades rotate in use. The cover is formed integrally out of plastic, has a screen for passage of water to the impeller and has outlets for delivering water from the impeller to the basin.

### FIELD OF THE INVENTION

The invention relates to the field of foot spa construction.

### BACKGROUND OF THE INVENTION

A known construction of a foot spa includes: a basin for containing water; a motor mounted exteriorly of the basin and having a rotating element; an impeller which is disposed interiorly of the basin and, in use, rotates to circulate water contained in the basin; and a magnetic coupling which couples the element to the impeller to provide for said rotation of the impeller.

Known magnetic couplings are relatively expensive to construct.

### SUMMARY OF THE INVENTION

Forming one aspect of the invention is an improved foot spa of the type including: a basin for containing water; a motor mounted exteriorly of the basin and having a rotating element; an impeller which is disposed interiorly of the basin and, in use, rotates to circulate water contained in the basin; and a magnetic coupling coupling the element to the impeller to provide for said rotation of the impeller.

The improvement comprises:
the coupling being defined by a drive hub coupled to the rotating element for rotation therewith and a driven hub coupled to the impeller for rotation therewith, one of the drive hub and the driven hub being a metal disc and the other having a surface which presents towards the metal disc and further having magnetic properties such that, in the absence of externalities, a magnetic field is produced which extends from and returns to the other hub, the magnetic field being characterized in that, if depicted graphically, concentrations of field lines would appear to extend from two or more North pole domains defined in the surface to two or more South pole domains defined in the surface, the North and South pole domains being spaced apart from each other and arranged to encircle the rotation axis in alternating relation;
the impeller being defined by blades carried by the driven hub; and
the housing being defined by a base and a cover: the base having a round recess defined therein which receives the disc in close-fitting relation; and the cover being secured to the base and defining, in combination therewith, a void in which the blades rotate in use, the cover being formed integrally out of plastic, having a screen defined therein for passage of water to the impeller and having outlets defined therein for delivering water from the impeller to the basin.

According to another aspect of the invention, the driven hub can be the metal disc and the blades can be formed integrally therewith.

According to another aspect of the invention, the metal disc can be copper or aluminum.

According to another aspect of the invention, the cover can have a pintle which projects through the void into a bushing defined in the impeller.

According to another aspect of the invention, the pintle can be ceramic-coated plastic.

According to another aspect of the invention, the screen can be defined by a plurality of arcuate slots.

According to another aspect of the invention, the base can have a ferromagnetic element which, in use, urges the base, cover and impeller against the basin.

According to another aspect of the invention, the ferromagnetic element can be a metallic ring about which the remainder of the base is injection molded out of plastic.

According to another aspect of the invention, the base can have a pair of ridges and the basin can have a pair of valleys, the ridges engaging the valleys in use to restrain rotational movement of the base relative to the basin.

According to another aspect of the invention, the two or more North pole domains can consist of two North pole domains and the two or more South pole domains can consist of two South pole domains.

The invention provides a magnetic coupling that is, inter alia, relatively inexpensive to construct in comparison to known magnetic couplings.

Further advantages, features and characteristics of the present invention will become apparent upon a review of the following detailed description with reference to the appended drawings, the latter being briefly described hereinafter.

### BRIEF DESCRIPTION OF THE DRAWINGS

FIG. 1 is a side cross-sectional view of a prior art foot spa

FIG. 2 is a partially exploded view of FIG. 1

FIG. 3 is a perspective view of the structure of encircled area 3 of FIG. 2;

FIG. 3A is a perspective view of the structure of FIG. 3, from another vantage point;

FIG. 4 is a perspective view of the structure of encircled area 4 of FIG. 2;

FIG. 5 is a perspective view of the structure of encircled area 5 of FIG. 2;

FIG. 6A is an exploded view of the structure of FIG. 3;

FIG. 6B is a view of the structure of FIG. 6A, from another vantage point;

FIG. 7 is an exploded view of the structure of encircled area 7 of FIG. 6B;

FIG. 8 is a cross-sectional view of encircled area 8 of FIG. 1;

FIG. 9 is a view similar to FIG. 1 of a foot spa assembly according to an exemplary embodiment of the invention;

FIG. 10 is a partially exploded view of the structure of FIG. 9;

FIG. 11 is a view of the structure of encircled area 11 of FIG. 10;

FIG. 11A is a view of the structure of FIG. 11, from another vantage point;

FIG. 12 is a perspective view of the structure of encircled area 12 of FIG. 10;

FIG. 13 is a perspective view of the structure of encircled area 13 of FIG. 10;

FIG. 14 is an exploded view of the structure of FIG. 11;

FIG. 14A is a view of the structure of FIG. 14, from another vantage point;

FIG. 15 is a rear plan view of the structure of encircled area 15 of FIG. 14

FIG. 16 is a view along section 16-16 of FIG. 15

FIG. 17 is an enlarged view of the structure of encircled area 17 of FIG. 16;

FIG. 18 is an enlarged cross-sectional view of encircled area 19 of FIG. 9; and

FIG. 19A is a view of the structure of FIG. 9 and a liner for use therewith; and

FIG. 19B is a view of the structures of FIG. 19A in use.

### DETAILED DESCRIPTION

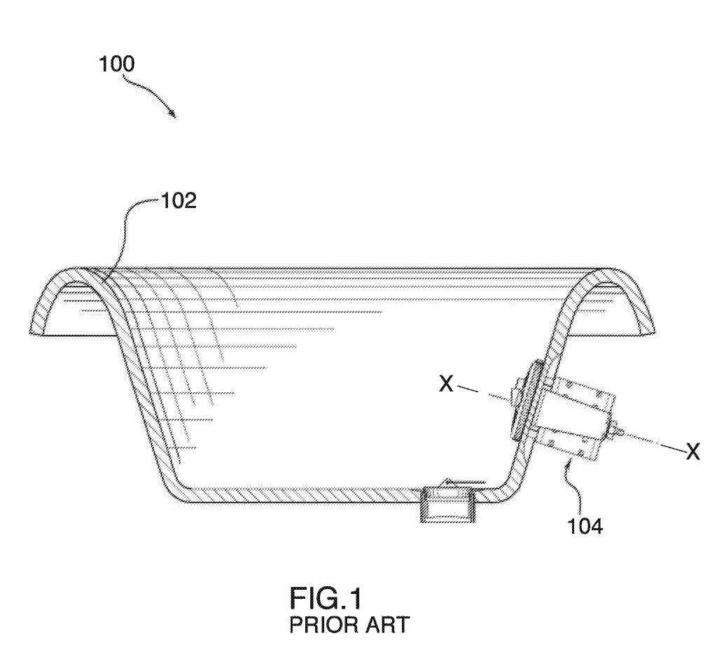

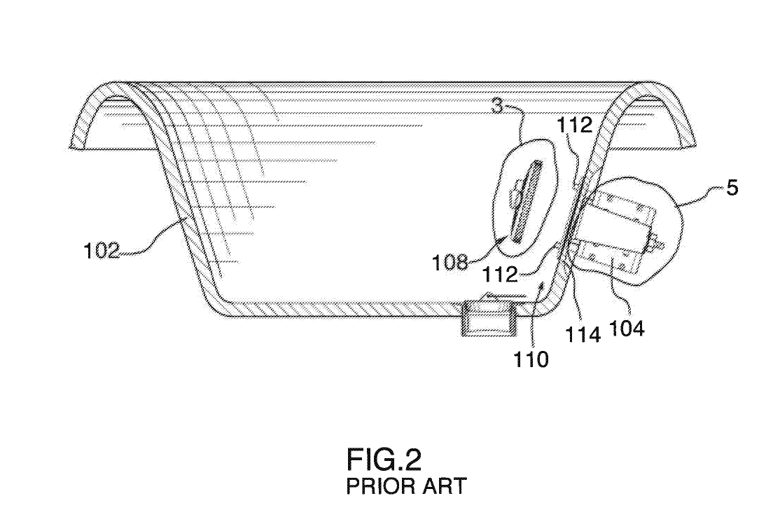

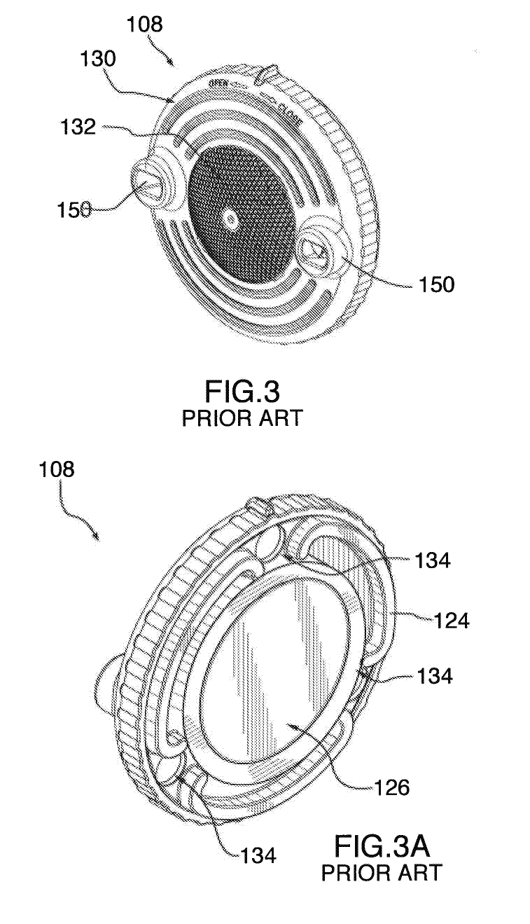

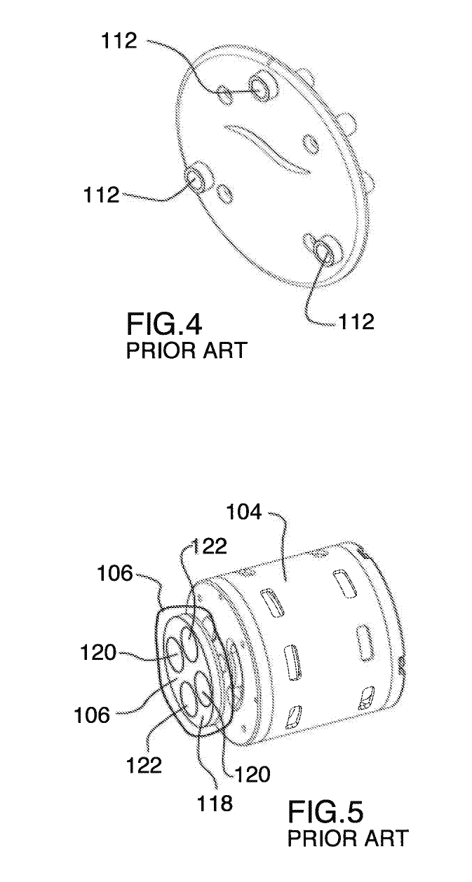

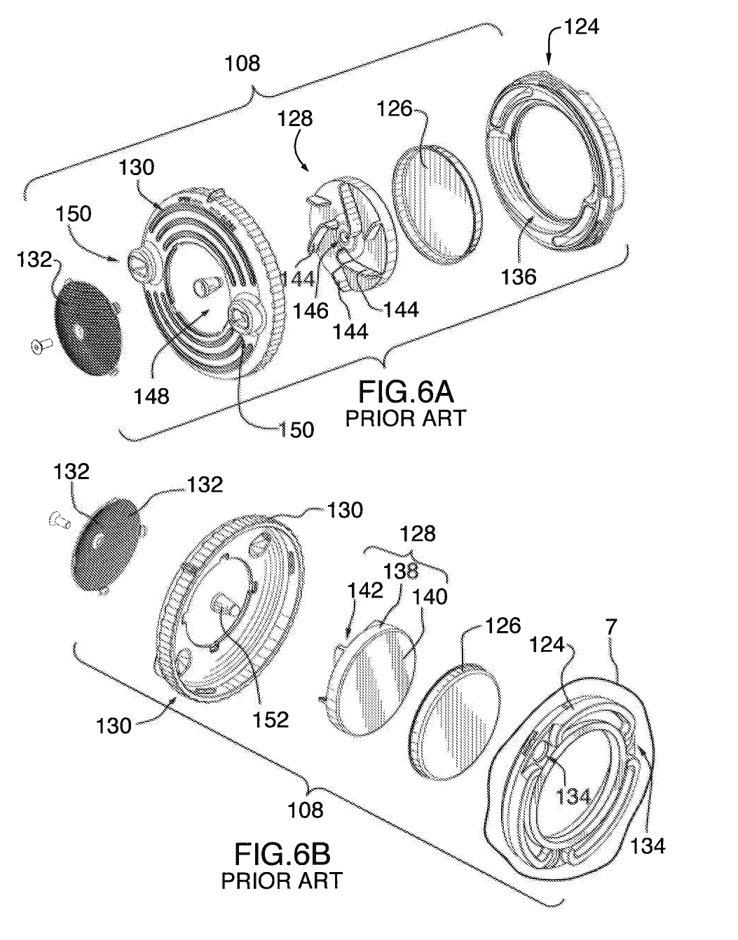

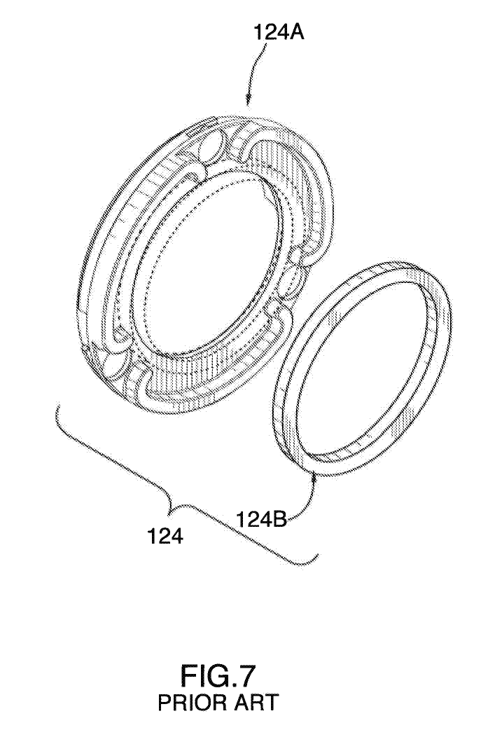

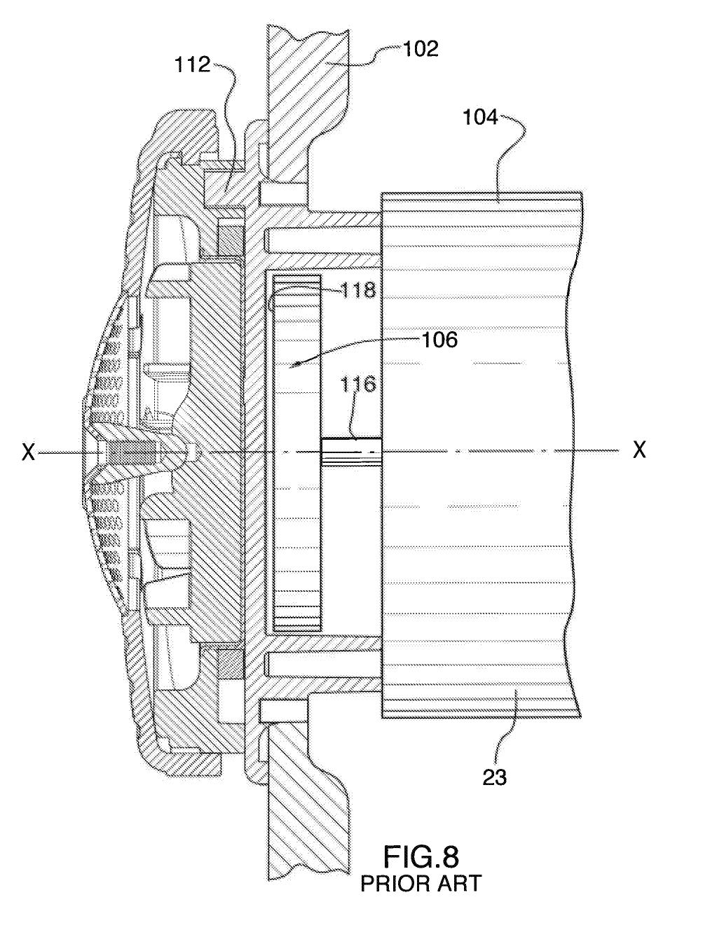

A foot spa 100 according to the prior art is shown in FIG. 1 through FIG. 8 and will be seen to include a basin 102, a motor 104, a drive hub 106 and a pump assembly 108.

The basin 102 is for containing water, is constructed of fibreglass, has a mounting area 110 having, interiorly of the basin, a plurality of projecting pins 112, and exteriorly of the basin, a recess portion 114.

The motor 104 is a conventional electric motor having a rotating element in the form of a shaft 116 which rotates in use about an axis X-X.

The drive hub 106 is mounted to the shaft 116 for rotation therewith about the axis X-X, the hub 106 having a front surface 118 which presents away from the rotating element and further having magnetic properties such that, in the absence of externalities, a magnetic field is produced which extends from and returns to the drive hub, the magnetic field being characterized in that, if depicted graphically, concentrations of field lines would appear to extend from two or more North pole domains 120 defined in the front surface to two or more South pole domains 122 defined in the front surface, the North and South pole domains being spaced apart from each other and arranged to encircle the rotation axis X-X in alternating relation.

The hub 106 will be seen to include a generally aluminum body 106′ with inserts 120,122 defining the domains.

The pump assembly 108 includes a base ring 124; a pan 126, an impeller 128, a cover 130 and a screen 132.

The base ring 124 has defined in the backside thereof a socket 134 for each pin and has a recess 136 defined therein. The base ring 124 is defined by a plastic part 124A and a metal ring part 124B which is secured to the plastic part 124A and is magnetically attracted by the hub 106.

The pan 126 is seated in the recess 136 and is formed of aluminum.

The impeller 128 includes an aluminum disc portion 138, a copper disc portion 140 secured to one side of the disc portion 138 and a blade portion 142 formed integrally with the aluminum disc portion and defining a plurality of blades 144, the blade portion further having a central recess 146.

The cover 130 has a circular central opening 148 and a pair of jet outlets 150.

The screen 132 is metal, is seated in the central opening 148 and has a spindle 152 extending centrally therefrom into the central recess 146.

The aluminum disc portion 138, copper disc portion 140, metal pan 126, screen 132 and drive hub 106 together define a magnetic coupling 138,140,126,132,106 which couples the blade portion 142 to the shaft 116 for rotation.

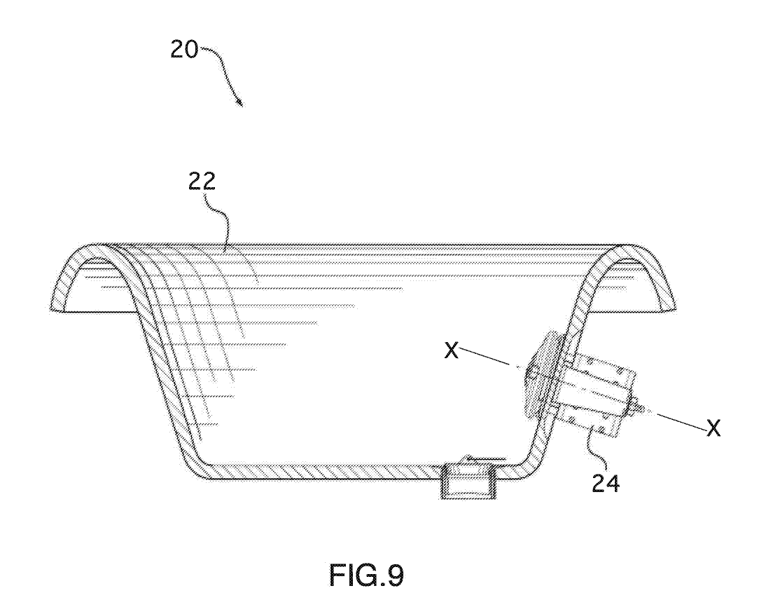

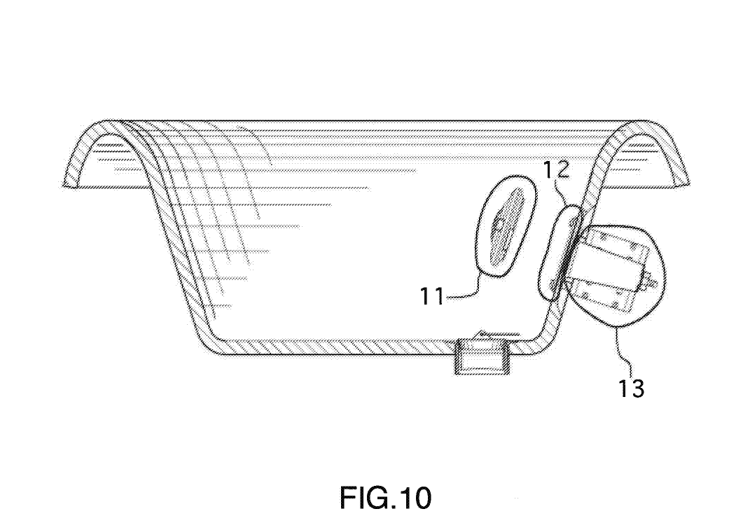

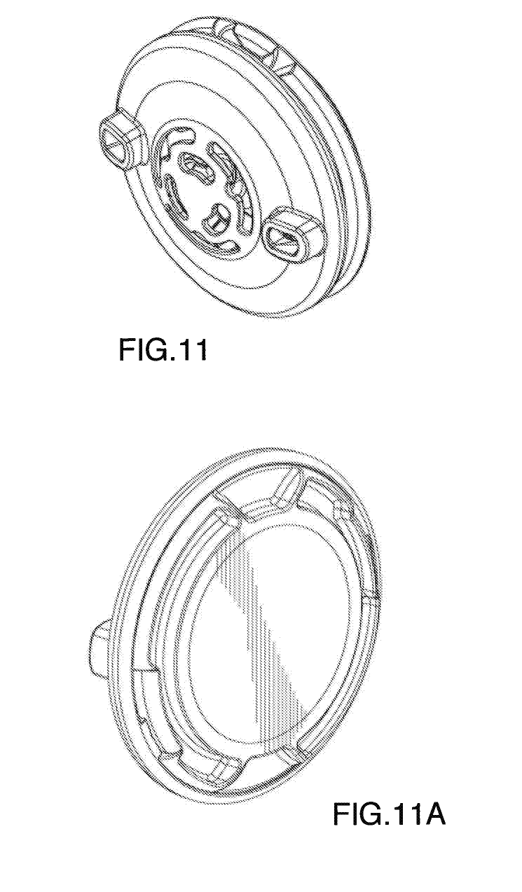

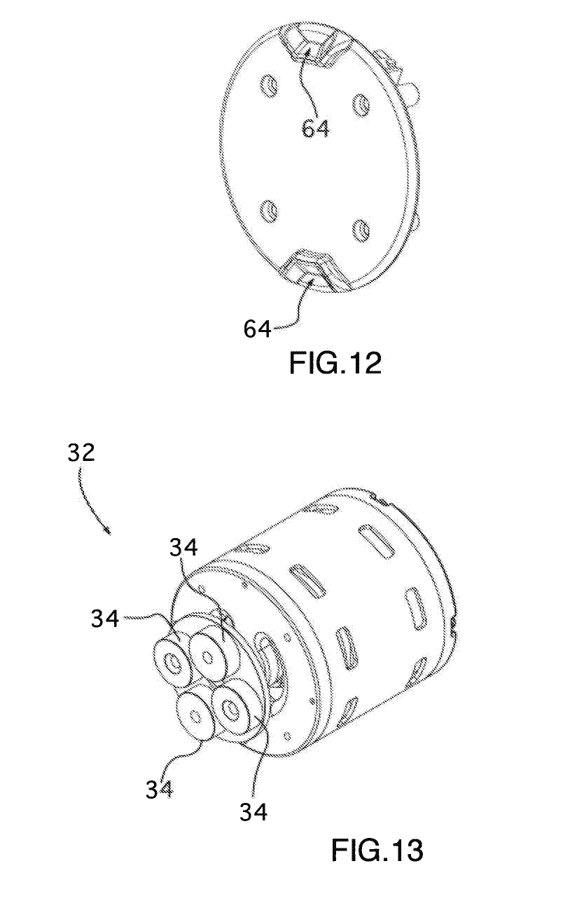

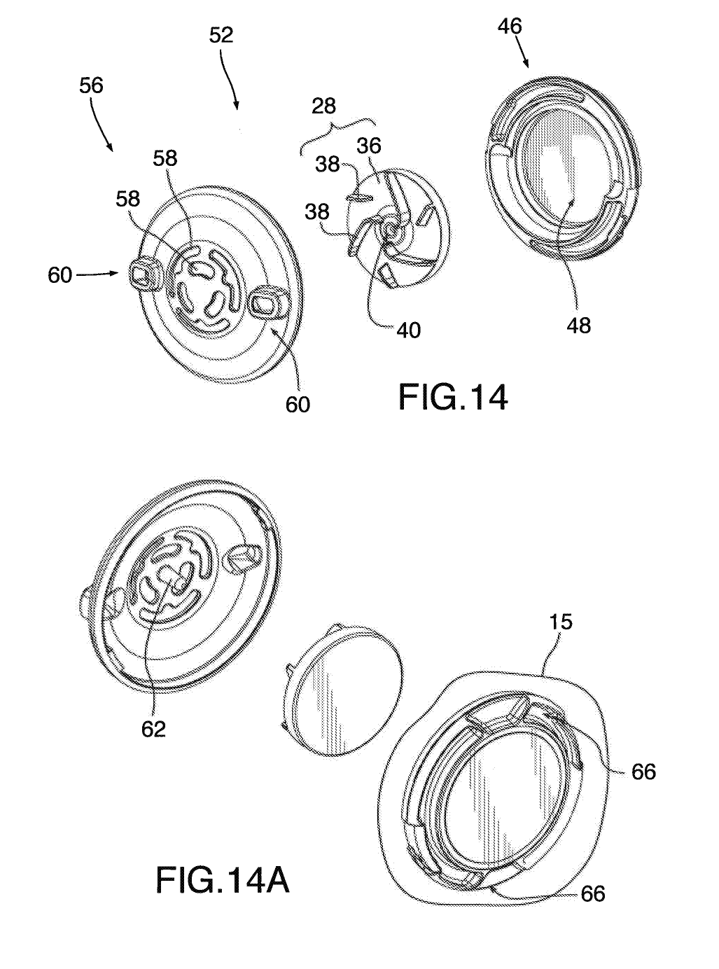

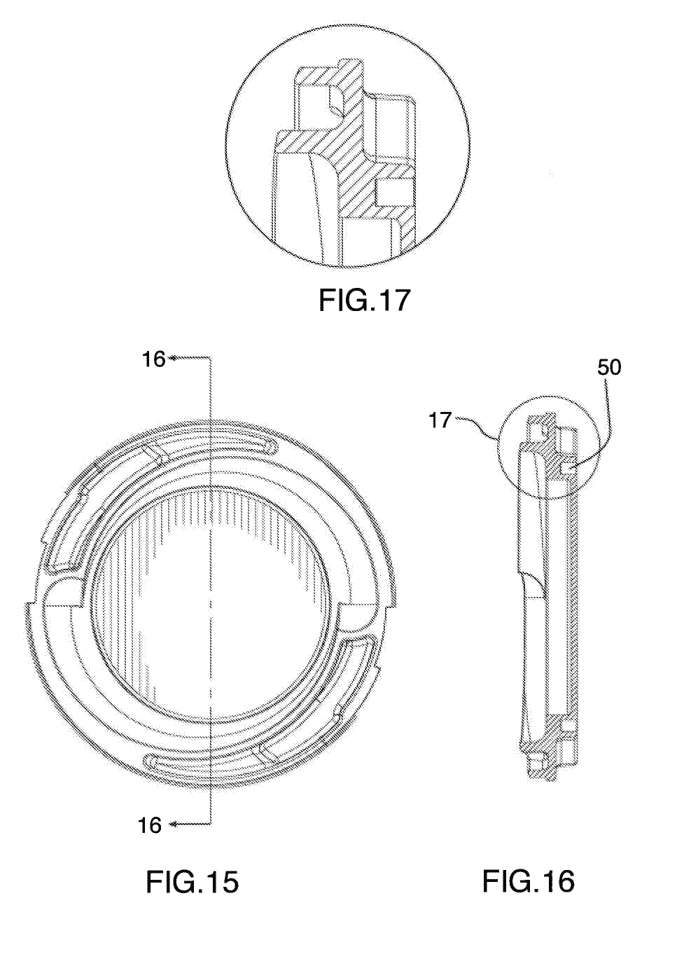

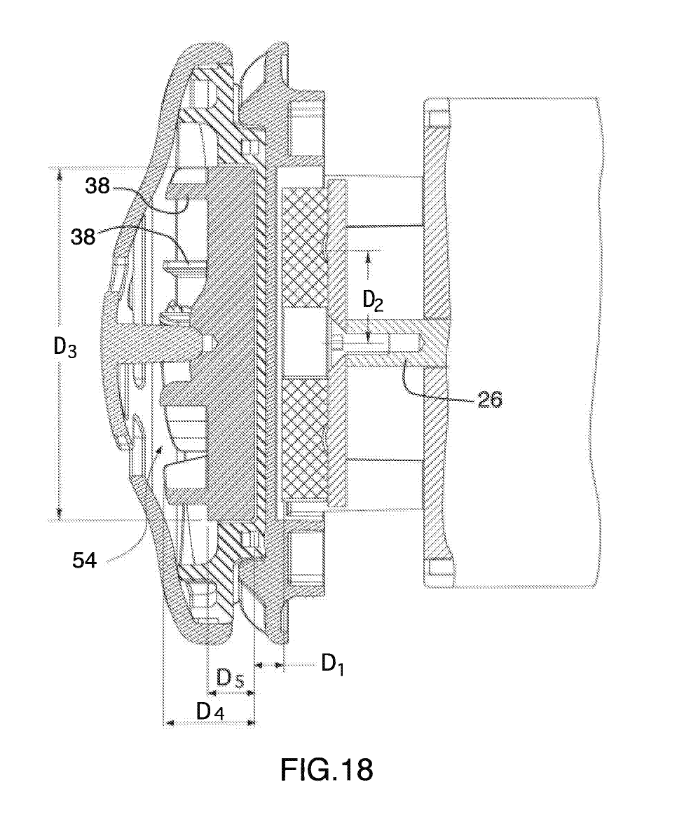

The exemplary embodiment 20 is shown in FIGS. 9 through 19 and will be seen to be generally similar to the prior art structure in that it includes, inter alia, a basin 22 for containing water; a motor 24 mounted exteriorly of the basin and having a rotating element 26; and an impeller 28 which is disposed interiorly of the basin and, in use, rotates to circulate water contained in the basin.

However, whereas the prior art magnetic coupling involved, inter alia, a screen 132, a pan 126, a copper disc 140 and an aluminum drive hub 106 having magnetic inserts 122, the exemplary embodiment will be understood to have a magnetic coupling 30 defined by:
a drive hub 32 having four discrete magnets 34; and
a metal disc 36 that is formed integrally with the impeller blades 38.

Further, whereas the pump assembly of the prior art structure included a plurality of elements including a base ring 124, a pan 126, a cover ring 130, a screen 132 and a spindle 152, a pump assembly 40 of the exemplary embodiment will be seen to be defined only by:
the impeller 28 formed of a metal disc 36 and blades 38 formed integrally with the disc, the impeller having a central recess 40 defined therein
a base 46: having a round recess 48 defined therein which receives the disc 36 in close-fitting relation; having a ferromagnetic element 50, namely, a metallic ring, about which the remainder of the base is injection-molded out of plastic and which, in use, urges the base, cover and impeller against the basin, under magnetic attraction from the magnetic domains of the drive hub; and
a cover 52 secured to the base, the cover:
   defining, in combination with the base, a void 54 in which the blades 38 rotate in use
   being formed integrally out of plastic
   having a screen 56 defined therein for passage of water to the impeller, the screen being defined by a plurality of arcuate slots 58
   having outlets 60 defined therein for delivering water from the impeller to the basin
   having a ceramic covered plastic spindle 62 which engages the recess 40 in the impeller

As well, whereas in the prior art, a plurality of pins extended from the basin and engage respective sockets in the pump assembly, in the exemplary embodiment, the pump assembly is restrained against rotational movement relative to the basin by: a pair of valleys 64 defined on the basin; and a pair of ridges 66 defined on the base that engage the valleys the valleys in use.

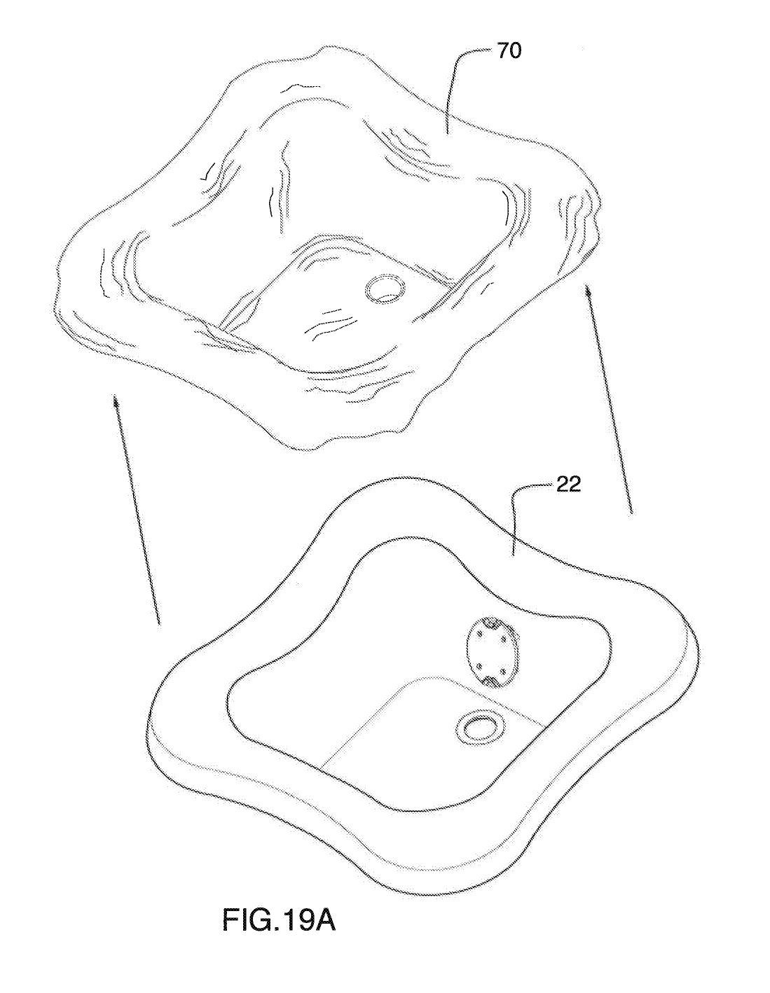

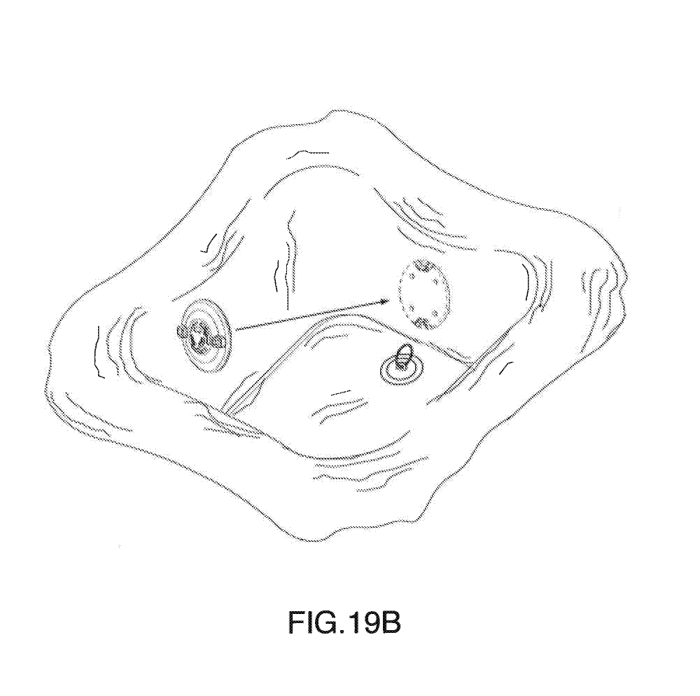

The improved spa has advantages compared to the prior art in numerous respects:
the three-part construction renders the pump assembly [base, cover and impeller] relatively inexpensive to manufacture;
the pump has relatively lower power consumption; and
the ridge/valley construction allows for a lightweight liner 70 to be interposed between the pump and the basin without perforation, as indicated by the sequence of FIG. 19A, 19B

Without intending to be bound by theory, the above advantages are perceived to flow from the geometry/structure of the pump which, inter alia, positions the impeller in close proximity to the drive hub, thereby allowing for, inter alia, the avoidance of the metal screen and metal pan in the prior art, which were believed to be necessary to obtain adequate magnetic field permeation in the context of relatively inexpensive magnets. In these regards, the inventive pump of the exemplary embodiment is characterized by the following:
the distance D1 in centimetres between the domains and the impeller is ¼″
the domains are each about 1″ in diameter and 3/16″ in thick and are N35 grade NdFeB permanent magnets
the centre of mass of each domain is a distance D2 from the rotation axis of about 9/16″
the diameter D3 of the impeller is 2 3/16″
the thickness D4 of the impeller is be 9/16″
the thickness D5 of the disc is 5/16″

Whereas a single embodiment is herein shown and described, variations are possible.

For example, whereas the impeller is indicated to be aluminum, it could be constructed out of copper.

As well, whereas specific ratios and other parameters are provided for the pump, it will be evident that variations therefrom are possible.

Further, whereas in the exemplary embodiment, the drive hub bears the magnet, the drive hub could be the metallic disc and the driven hub could carry the magnets.

Accordingly, the invention should be understood to be limited only by the accompanying claims, purposively construed.

1. An improved foot spa of the type including: a basin for containing water; a motor mounted exteriorly of the basin and having a rotating element; an impeller which is disposed interiorly of the basin and, in use, rotates to circulate water contained in the basin; and a magnetic coupling coupling the element to the impeller to provide for said rotation of the impeller, wherein the improvement comprises:
the magnetic coupling being defined by a drive hub coupled to the rotating element for rotation
therewith and a driven hub coupled to the impeller for rotation therewith, one of the drive hub and the driven hub being a metal disc and the other having a surface which presents towards the metal disc and further having magnetic properties such that, in the absence of externalities, a magnetic field is produced which extends from and returns to the other hub, the magnetic field being characterized in that, if depicted graphically, concentrations of field lines would appear to extend from two or more North pole domains defined in the surface to two or more South pole domains defined in the surface, the North and South pole domains being spaced apart from each other and arranged to encircle the rotation axis in alternating relation
the impeller being defined by blades carried by the driven hub; and
a housing defined by a base and a cover:
the base having a round recess defined therein which receives the disc in close-fitting relation; and the cover being secured to the base and defining, in combination therewith, a void in which the blades rotate in use, the cover being formed integrally out of plastic, having a screen defined therein for passage of water to the impeller and having outlets defined therein for delivering water from the impeller to the basin.

2. An improved spa according to claim 1, wherein the driven hub is the metal disc and the blades are formed integrally therewith.

3. An improved spa according to claim 2, wherein the metal disc is copper or aluminum.

4. An improved spa according to claim 1, wherein the cover has a pintle which projects through the void into a bushing defined in the impeller.

5. An improved spa according to claim 1, wherein the pintle is ceramic-coated plastic.

6. An improved spa according to claim 1, wherein the screen is defined by a plurality of arcuate slots.

7. An improved spa according to claim 1, wherein the base has a ferromagnetic element which, in use, urges the base, cover and impeller against the basin.

8. An improved spa according to claim 7, wherein the ferromagnetic element is a metallic ring about which the remainder of the base is injection molded out of plastic.

9. An improved spa according to claim 1, wherein the base has a pair of ridges and the basin has a pair of valleys, the ridges engaging the valleys in use to restrain rotational movement of the base relative to the basin.

10. An improved spa according to claim 1, wherein the two or more North pole domains consist of two North pole domains and the two or more South pole domains consist of two South pole domains.
